(19) United States
(12) Patent Application Publication
(10) Pub. No.: US 2012/0209595 A1
(43) Pub. Date: Aug. 16, 2012

(54) DICTIONARY INFORMATION DISPLAY DEVICE AND DICTIONARY INFORMATION DISPLAY METHOD

(75) Inventor: Makoto Hokuchi, Hamura-shi (JP)

(73) Assignee: CASIO COMPUTER CO., LTD., Tokyo (JP)

(21) Appl. No.: 13/353,461

(22) Filed: Jan. 19, 2012

(30) Foreign Application Priority Data
Feb. 14, 2011 (JP) 2011-028560

(51) Int. Cl. G06F 17/21

(52) U.S. Cl. 704/10; 704/E11.001

(57) ABSTRACT

A dictionary information display device displays explanatory information on a desired search word retrieved from dictionary data on a main display module, creates list data about examples, descriptions, and phrases incidental to each word meaning included in the explanatory information, and displays, on an auxiliary display module, a supplementary information list screen that arranges the beginning parts of the individual examples, descriptions, and phrases line by line in headline form. When the user selects any one of the examples, descriptions, and phrases on the list screen displayed by the auxiliary display module, the entire contents of the selected example or description are displayed by the auxiliary display module.

### CROSS-REFERENCE TO RELATED APPLICATIONS

This application is based upon and claims the benefit of priority from prior Japanese Patent Application No. 2011-028560, filed Feb. 14, 2011, the entire contents of which are incorporated herein by reference.

### BACKGROUND OF THE INVENTION

1. Field of the Invention

Embodiments described herein relate generally to a dictionary information display device and a dictionary information display method which retrieve an entry word included in a dictionary and display its explanatory information.

2. Description of the Related Art

In a normal paper dictionary, an entry word is generally followed by its word meaning. If there is supplementary information, including its examples (example sentences), descriptions, phrases, and idioms, the information is written behind the word meaning. In the case of a word with a plurality of meanings, if there is supplementary information, it will be written behind each word meaning. With the normal paper dictionary, for example, when the user wants to consult a dictionary for an example of an entry word, he or she can find the example at the first glance by opening the dictionary to a page on which the entry word appears.

On the other hand, with a conventional electronic dictionary device, when a desired entry word is searched for and its explanatory information is displayed, an example or a description caused to correspond to each word meaning of the explanatory information is displayed in such a manner that its existence appears as an icon in the position of each item of word meaning information. When the user wants to see an example, he or she specifies an [Example] icon by a touch operation or a key operation, causing the contents of the example to be read and displayed.

In addition, when there is a phrase or an idiom corresponding to the retrieved entry word, [Phrase] or [Idiom] mark is displayed on the display screen of explanatory information corresponding to the entry word. When the user specifies the mark by a touch operation or a key operation, the phrase or idiom is read and displayed.

As disclosed in Jpn. Pat. Appln. KOKAI Publication No. 2004-213313, an electronic dictionary device has been proposed which accepts the input or selection of an additional word when displaying examples of the retrieved entry word, searches the examples corresponding to the entry word for an example including the additional word, and displays the example, thereby enabling the example meeting the user's intention to be displayed.

In the case of an electronic dictionary device with a limited screen size, when explanatory information is displayed, if the amount of explanatory information is very large, the user cannot look over the whole explanation unless scrolling the display screen. Furthermore, the user cannot know what items of supplementary information are further included in the entire data structure in addition to the explanatory information.

Therefore, with the electronic dictionary device, the user cannot know, at the first glance, where the desired part is written in the search result and goes to the trouble of scrolling the display screen to reach the part the user wants to see.

### BRIEF SUMMARY OF THE INVENTION

According to an embodiment of the invention, there is provided a dictionary information display device and a dictionary information display method which enable the user not only to grasp the entire data structure of explanatory information easily but also to look at desired supplementary information readily when displaying the explanatory information.

A dictionary information display device according to an embodiment of the invention comprises a dictionary data storage module which stores dictionary data that correlates a plurality of entry words with items of explanatory information about the individual entry words in a one-to-one correspondence, an explanatory information display module which reads explanatory information corresponding to an entry word retrieved according to a user operation from the dictionary data and displays the explanatory information on a first screen, a supplementary information list display module which reads items of supplementary information incidental to explanatory information corresponding to the retrieved entry word from the dictionary data and displays a list of the items of supplementary information on a second screen, and a supplementary information display module which displays an item of supplementary information selected according to a user operation from the items of supplementary information displayed by the supplementary information list display module on the second screen.

A dictionary information display method according to another embodiment of the invention is a method of displaying dictionary information in a dictionary information display device which includes a dictionary data storage module which stores dictionary data that correlates a plurality of entry words with items of explanatory information about the individual entry words in a one-to-one correspondence and a display module that includes a first and a second display screen. The dictionary information display method comprises reading explanatory information corresponding to an entry word retrieved according to a user operation from the dictionary data and displaying the explanatory information on a first screen, reading items of supplementary information incidental to explanatory information corresponding to the retrieved entry word from the dictionary data and displaying a list of the items of supplementary information on a second screen, and displaying, on the second screen, an item of supplementary information selected according to a user operation from the items of supplementary information displayed in list form.

According to the embodiments of the invention, when explanatory information on a retrieved entry word is displayed, the user can not only grasp the entire data structure of the explanatory information easily but also look at information about a desired part readily.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing an outer configuration of an electronic dictionary device 10 according to an embodiment of a dictionary information display device of the invention;

FIG. 2 is a block diagram showing a configuration of the electronic circuitry of the electronic dictionary device 10;

FIG. 3 is a flowchart to explain a dictionary search process performed by the electronic dictionary device 10;

FIG. 4 is a flowchart to explain the process of creating auxiliary screen data in connection with the dictionary search process by the electronic dictionary device 10;

FIG. 5 shows a data structure of [English-Japanese dictionary] 22b2 stored in a dictionary database 22b of the electronic dictionary device 10 and a created image of list data L on examples, descriptions, and phrases resulting from the process of creating auxiliary screen data in connection with the dictionary search process;

FIG. 6 shows a display operation (part 1) of a main display module 16 and an auxiliary display module 15 in connection with the dictionary search process by the electronic dictionary device 10; and

FIG. 7 shows a display operation (part 2) of the main display module 16 and auxiliary display module 15 in connection with the dictionary search process by the electronic dictionary device 10.

### DETAILED DESCRIPTION OF THE INVENTION

Hereinafter, referring to the accompanying drawings, an embodiment of the invention will be explained.

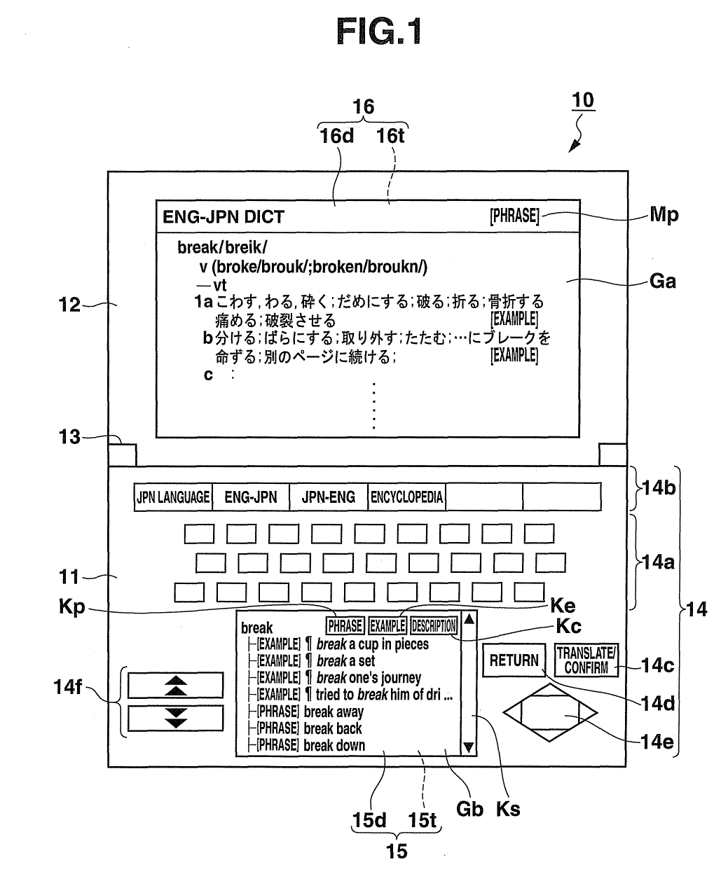

FIG. 1 is a front view showing an outer configuration of an electronic dictionary device 10 according to an embodiment of a dictionary information display device of the invention.

The electronic dictionary device 10 is configured as a portable device dedicated to an electronic dictionary explained below or as a personal digital assistant (PDA), a personal computer (PC), a cellular phone, an electronic book reader, a portable video game console, or the like each of which has a dictionary function.

The electronic dictionary device 10 is so configured that a body case 11 and a cover case 12 are coupled with each other via a hinge part 13 so as to form a foldable case that can be opened and closed. At the surface of the body case 11 with the foldable case opened, there are provided a key input module (keyboard) 14 and a handwriting input module (hereinafter, referred to as an auxiliary display module) 15. The key input module 14 comprises character input keys 14a, dictionary specify keys 14b, [Translate/Confirm] key 14c, [Return] key 14d, cursor key 14e, and page feed keys 14f.

The auxiliary display module 15 has a structure where a touch position detecting device that detects a position touched by the user with a stylus, a finger, or the like and a display device are integrally formed. The auxiliary display module 15 is so configured that, for example, a transparent touch panel 15t is laid on a 256×64 dot backlight color liquid-crystal display screen 15d on the front side of the central part of the key input module 14. The auxiliary display module 15 displays a list of [Example], [Description], and [Phrase] incidental to explanatory information searched for in a dictionary. In addition, the auxiliary display module 15 is switched between a handwriting character input area for inputting a handwriting character and a key input area for various functions as needed.

A trace of handwriting input in the handwriting character input area switched on the auxiliary display module 15 is echoed back to the backlight color liquid-crystal display screen 15d, which displays the trace.

At the surface of the cover case 12, for example, a 480×320 dot touch panel display module (hereinafter referred to as a main display module) 16 with a backlight is provided on almost all the surface. Like the auxiliary display module 15, the main display module 16 has a structure where a display device and a touch position detecting device that detects a position touched by the user with a stylus, a finger, or the like are integrally formed. The main display module 16 is so configured that a transparent touch panel 16t is laid on a backlight color liquid-crystal display screen 16d.

The electronic dictionary device 10 has the function of displaying a supplementary information list screen Gb that shows a list of [Example], [Description], and [Phrase] incidental to the explanatory information on the auxiliary display module 15 when an explanatory information display screen Ga corresponding to an entry word retrieved according to a user operation is displayed by the main display module 16.

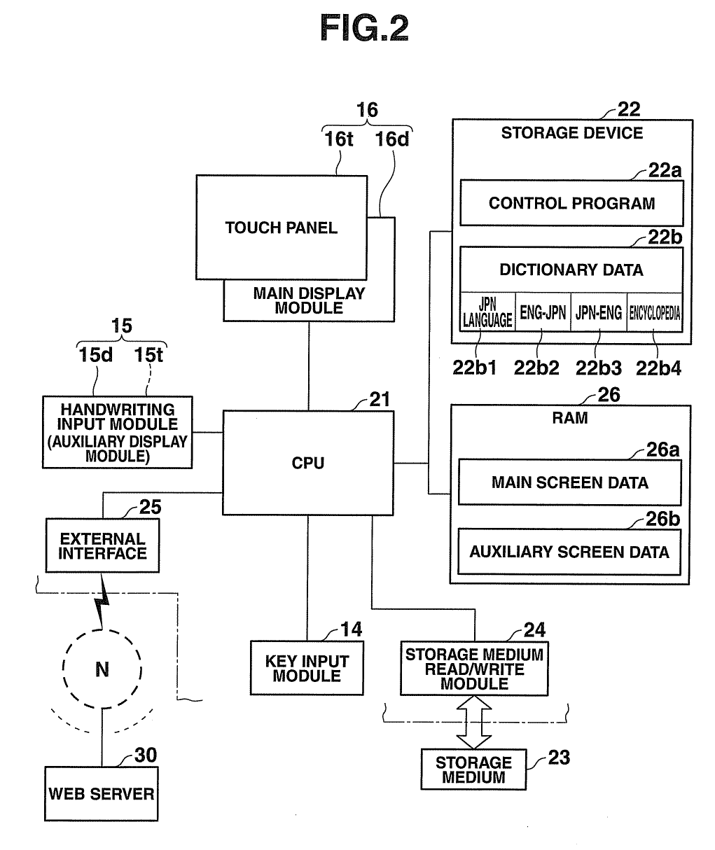

FIG. 2 is a block diagram showing a configuration of the electronic circuitry of the electronic dictionary device 10.

The electronic dictionary device 10 is composed of a computer which reads programs recorded in various storage mediums and is controlled by the read programs. The electronic circuitry of the device 10 comprises a central processing unit (CPU) 21.

The CPU 21 controls the operation of each of the various parts of the circuitry using a RAM 26 as a work memory according to a device control program 22a prestored in the memory device 22. The device control program 22a may be read into the storage device 22 from an external storage medium 23, such as a ROM card, via a storage medium read/write module 24, or from a Web server (in this case, a program server) 30 on the Internet N via an external interface 25.

The device control program 22a stored in the memory device 22 is activated in response to an input signal corresponding to a user operation from the key input module 14, auxiliary display module 15, or main display module 16.

Connected to the CPU 21 are the memory device 22, storage medium read/write module 24, external interface 25, RAM 26, key input module 14, auxiliary display module 15, and main display module 16.

Stored as the device control programs 22a in the memory device 22 are a system program that supervises the operation of the entire electronic dictionary device 10 and a communication program for performing data communication with each Web server 30 on the Internet N via the external interface 25. Further stored as the device control program 22a is a dictionary search program for controlling overall processes, including search, edit, and display, based on the dictionary database 22b stored in the storage device 22. The dictionary search program performs the process of inputting and recognizing handwritten characters in a dictionary function, the process of inputting a search word, the process of retrieving an entry word corresponding to a search word, the process of displaying retrieved entry words in list form, the process of reading and displaying various items of explanatory information, including translations, semantic contents, examples, descriptions, and phrases, corresponding to an entry word specified by the cursor, and the process of displaying the beginning parts of items of supplementary information, including examples, descriptions, and phrases, included in explanatory information in list form.

In the dictionary database 22b, not only [Japanese-language dictionary] 22b1, [English-Japanese dictionary] 22b2, [Japanese-English dictionary] 22b3, and [Encyclopedia] 22b4 but also a plurality of types of dictionary data have been previously stored or downloaded and stored.

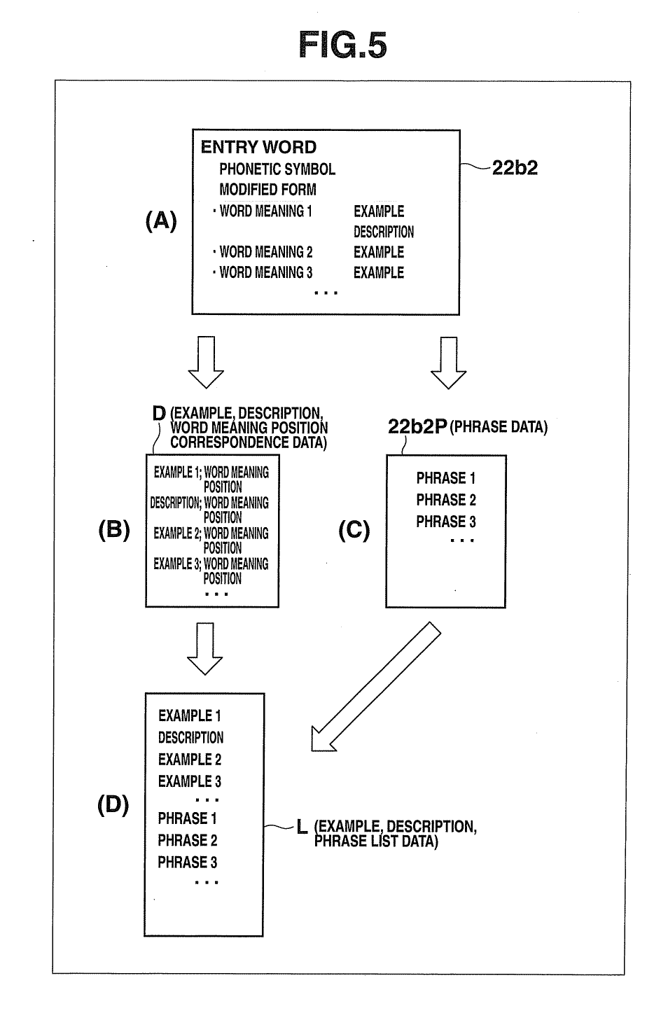

In the dictionary data of [English-Japanese dictionary] 22b2, items of explanatory information are recorded so as to correspond to English entry words in alphabetical order. The items of explanatory information have a tree-shaped data structure where phonetic symbols, modified forms, and word meanings are included in that order and each word meaning includes an example and a description as supplementary information ([A] in FIG. 5). A phrase about each entry word is included differently from explanatory information as supplementary information in the form of phrase data 22b2p ([C] in FIG. 5) caused to correspond to the entry word.

In the RAM 26, a main screen data memory 26a and an auxiliary screen data memory 26b are secured.

In the main screen data memory 26a, display data to be displayed by the main display module 16 is developed into a bitmap pattern and stored.

In the auxiliary screen data memory 26b, display data to be displayed by the auxiliary display module 15 is developed into a bitmap pattern and stored.

In the electronic dictionary device 10 configured as described above, the CPU 21 controls the operation of each part of the circuit according to instructions written in the device control program 22a so as to cause software and hardware to operate in cooperation with each other, thereby realizing functions described below.

Next, the operation of the electronic dictionary device 10 with the above configuration will be explained.

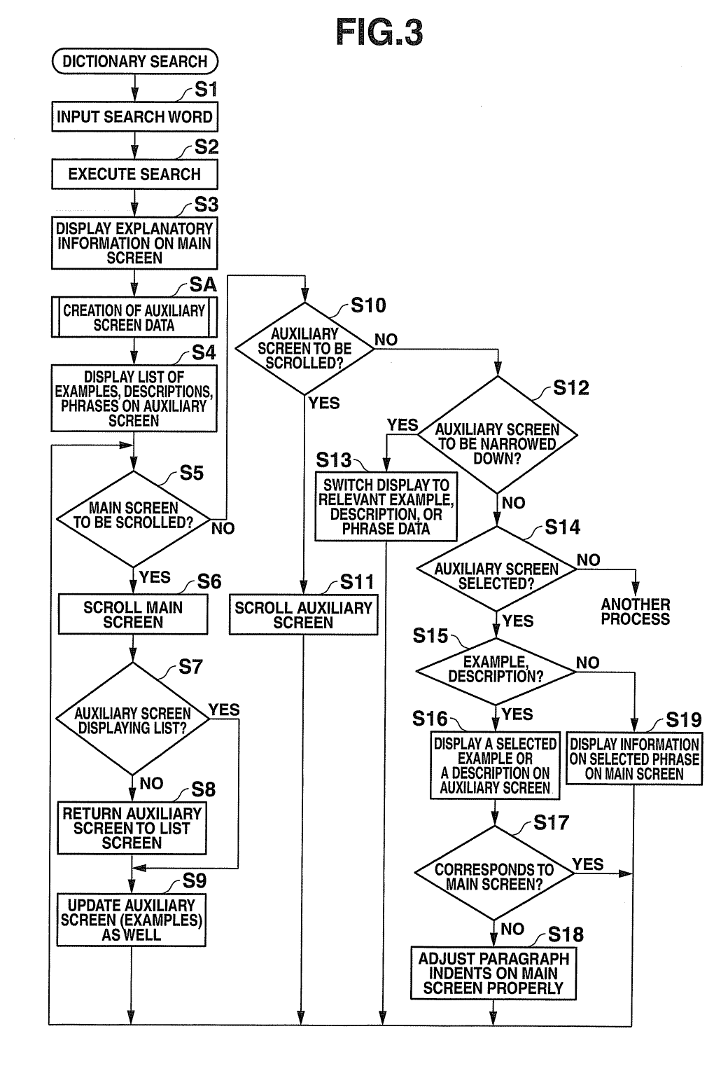

FIG. 3 is a flowchart to explain a dictionary search process performed by the electronic dictionary device 10.

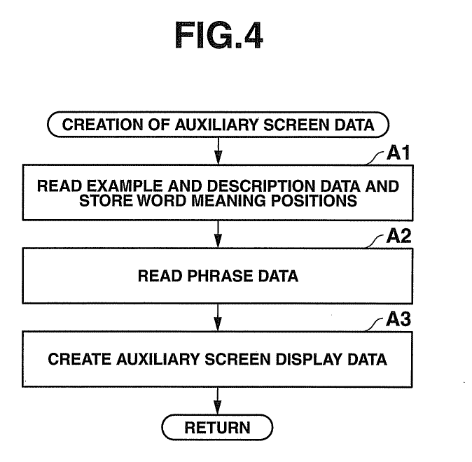

FIG. 4 is a flowchart to explain the process of creating auxiliary screen data in connection with the dictionary search process by the electronic dictionary device 10.

FIG. 5 shows a data structure of [English-Japanese dictionary] 22b2 stored in the dictionary database 22b of the electronic dictionary device 10 and a created image of list data L on examples, descriptions, and phrases resulting from the process of creating auxiliary screen data in connection with the dictionary search process.

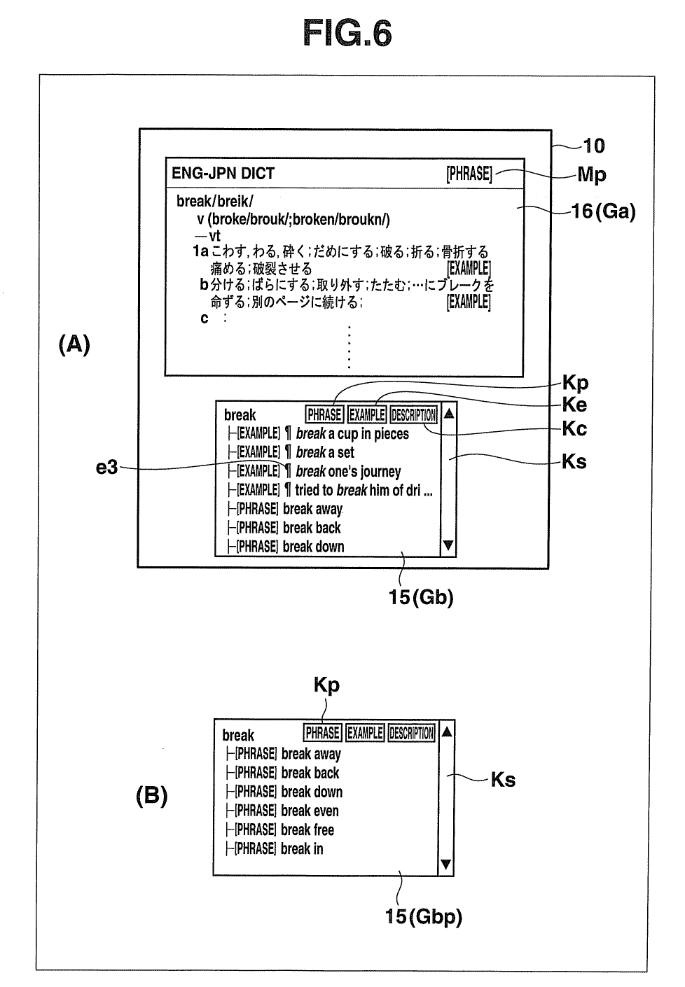

FIG. 6 shows a display operation (part 1) of the main display module 16 and auxiliary display module 15 in connection with the dictionary search process by the electronic dictionary device 10.

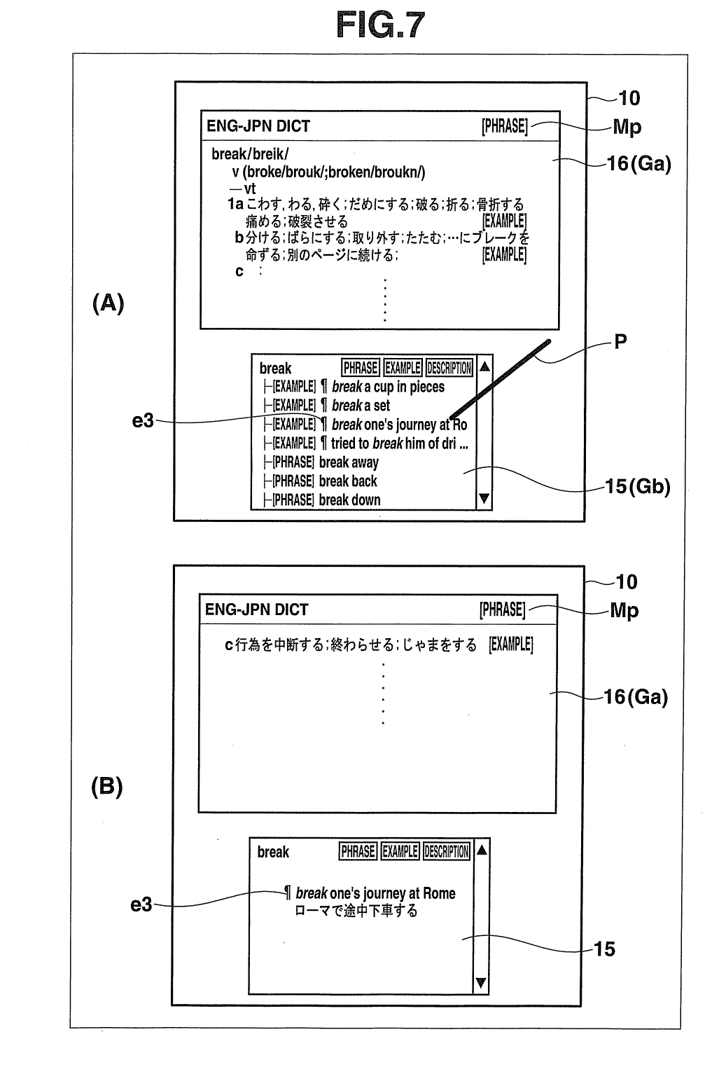

FIG. 7 shows a display operation (part 2) of the main display module 16 and auxiliary display module 15 in connection with the dictionary search process by the electronic dictionary device 10.

When [English-Japanese dictionary] 22b2 has been specified according to a user operation on the display specify keys 14b, a search word input screen for the English-Japanese dictionary is initially displayed by the main display module 16.

On the search word input screen, when a search word is input according to a user operation on the character input keys 14a or the handwriting input module 15 (step S1), an entry word (single word) that coincides in the front with the input search word is retrieved from [English-Japanese dictionary] 22b2 and a list screen of entry words is displayed as the search result on the main display module 16 (step S2).

When the user selects a desired entry word on the entry word list screen, explanatory information corresponding to the selected entry word is read from [English-Japanese dictionary] 22b2 and displayed by the main display module 16 (step S3). In FIG. 6, (A) shows an explanatory information display screen Ga when [break] has been selected as an entry word.

If there are an example and a description as supplementary information for each word meaning of entry word [break] on the explanatory information list screen Ga, an [Example] icon and a [Description] icon are displayed behind word meaning information. If there is a phrase about the entry word, [Phrase] mark Mp is displayed in the upper part of the explanatory information list screen Ga.

Then, control is passed to the process of creating auxiliary screen data shown in FIG. 4, thereby creating display data to be displayed by the auxiliary display module 15 (step SA).

In the process of creating auxiliary screen data, first, data on examples and descriptions incidental to each word meaning in explanatory information stored in the [English-Japanese dictionary] 22b2 with a data structure as shown by (A) in FIG. 5 is read in accordance with the retrieved entry word [break] and stored as example, description, word meaning position correspondence data D caused to correspond to each word meaning position into the RAM 26 as shown by (B) in FIG. 5 (step A1).

In addition, phrase data 22b2p stored in [English-Japanese dictionary] 22b2 is read so as to correspond to the retrieved entry word [break] as shown by (C) in FIG. 5 (step A2).

Then, example, description, phrase list data L is created as shown by (D) in FIG. 5 (step A3). The example, description, phrase list data L is obtained by combining the example, description data in the example, description, word meaning position correspondence data D ([B] in FIG. 5) stored in the RAM 26 in step A1 with the phrase data 22b2p ([C] in FIG. 5) read in step A2. Then, a supplementary information list screen Gb for entry word [break] is displayed by the auxiliary display module 15 (step S4). On the supplementary information list screen Gb, the heads of individual data items are suitably indented on the basis of the data L as shown in FIG. 6.

At this time, on the supplementary information list screen Gb, the contents of examples, descriptions, and phrases in the example, description, phrase list data L are displayed as much as can be displayed in one line in headline form on the auxiliary display module 15.

In addition, in the upper part of the supplementary information list screen Gb, [Phrase] key Kp for making a short list of only phrases, [Example] key Ke for making a short list of only examples, and [Description] key Kc for making a short list of only descriptions are displayed. On the right side of the supplementary information list screen Gb, a scroll bar Ks for scrolling a list of data is displayed.

When the explanatory information display screen Ga and supplementary information list screen Gb have been displayed, it is determined whether the user has performed any operation (steps S5, S10, S12, S14). If it has been determined that the user has given an instruction to scroll the main display module 16 (explanatory information display screen Ga) by operating the cursor key 14e (step S5), explanatory information on entry word [break] displayed by the main display module 16 (explanatory information display screen Ga) is scrolled in response to the scroll operation.

At that time, if it has been determined that the supplementary information list screen Gb is currently being displayed by the auxiliary display module 15 (Yes in step S7), the position of examples displayed by the auxiliary display module 15 (supplementary information list screen Gb) is also updated to the word meaning position in explanatory information in response to the scrolling of the main display module 16 (explanatory information display screen Ga) (step S9).

When the main display module (explanatory information display screen Ga) 16 has been scrolled (steps S5, S6), if it has been determined that the supplementary information list screen Gb has not been displayed by the auxiliary display module 15 (No in step S7), the displayed contents of the auxiliary display module 15 are returned to the supplementary information list screen Gb (step S8) and then the position of an example displayed on the supplementary information list screen Gb is updated to the word meaning position in the explanatory information in accordance with the scrolling (step S9).

On the other hand, if it has been determined that the auxiliary display module has been scrolled with the scroll bar Ks displayed at the right end of the auxiliary display module 15 (Yes in step S10), the contents currently displayed by the auxiliary display module 15 are scrolled (step S11).

As shown by (A) in FIG. 6, when any one of narrow-down keys, [Phrase] key Kp, [Example] key Ke, and [Description] key Kc, displayed on the supplementary information list screen Gb of the auxiliary display module 15 has been touched (Yes in step S12), data is narrowed down to items corresponding to the specified key and displayed (step S13). For example, when [Phrase] key Kp is touched, a phrase list screen Gbp that has narrowed down the example, description, phrase list data L ([D] in FIG. 5) to only [Phrase] data 22b2p is created and displayed by the auxiliary display module 15 as shown by (B) in FIG. 6.

In addition, as shown by (A) in FIG. 7, with the explanatory information display screen Ga corresponding to entry word [break] and the supplementary information list screen Gb being displayed, when, for example, a third [Example] [break one's . . . ] e3 displayed on the supplementary information list screen Gb has been touched and selected with stylus P (Yes in step S14), the whole content [break one's journey at Rome] e3 of the selected [Example] e3 is read from [English-Japanese dictionary] 22b2 and displayed by the auxiliary display module 15 as shown by (B) in FIG. 7 (Yes in steps S15-+S16).

At this time, it is determined whether the selected [Example] e3 displayed by the auxiliary display module 15 corresponds to the word meaning position in explanatory information currently displayed by the main display module 16 (step S17). This determination is made on the basis of the example, description, word meaning position correspondence data D ([B] in FIG. 5) stored in the RAM 26 in step A1 in the process of creating auxiliary screen data (FIG. 4).

If it has been determined that [Example] e3 displayed by the auxiliary display module 15 does not correspond to the word meaning position of explanatory information currently displayed by the main display module 16 (No in step S17), a first word meaning position in explanatory information displayed by the main display module 16 is scrolled to “c [symbol] : [symbol] [symbol] : [symbol] . . . ” in correspondence with the word meaning position of [Example] “break one's journey at Rome” e3 as shown by (B) in FIG. 7 and is displayed properly (step S18).

On the supplementary information list screen Gb ([A] in FIG. 7) displayed by the auxiliary display module 15, for example, when [Phrase] [break down] has been touched and selected with stylus P (step S14 [yes]→S15 [no]), the whole contents of the selected [Phrase] “break down [ [symbol] ] (1)< [symbol] · [symbol] > [symbol] . . . ” is read from [English-Japanese dictionary] 22b2 and displayed by the main display module 16 (step S19).

Therefore, with the dictionary search function of the electronic dictionary device 10 with the above configuration, when explanatory information on a word is displayed by the main display module 16, example, description, and phrase list data D ([D] in FIG. 5) for each word meaning included in the explanatory information is created and displayed as a supplementary information list screen Gb on the auxiliary display module 15. When any one of the examples, descriptions, and phrases on the supplementary information list screen Gb displayed by the auxiliary display module 15 is touched and selected with the stylus, the contents will be displayed by the auxiliary display module 15 in the case of an example or a description or on the main display module 17 in the case of a phrase.

Accordingly, the user can grasp the data structure of explanatory information easily by looking at a list of examples, descriptions, and phrases displayed by the auxiliary display module 15. In addition, the user can selectively display desired dictionary information, including [Example], [Description], and [Phrase], swiftly and easily by touching the supplementary information list screen Gb displayed by the auxiliary display module 15.

While in the embodiment, the supplementary information list screen Gb has been displayed by the auxiliary display module 15 provided separately from the main display module 16, it may be displayed as a different window on the main display module 16.

The methods of the individual processes performed by the electronic dictionary device 10, including the dictionary search process shown in the flowchart of FIG. 3 and the process of creating auxiliary screen data in connection with the dictionary search process shown in the flowchart of FIG. 4, and the databases, including the dictionary database 22b including [English-Japanese dictionary] 22b2, written in the embodiment can be stored in the external storage media 23, such as a memory card (e.g., a ROM card or a RAM card), a magnetic disk (e.g., a floppy disk or a hard disk), an optical disk (e.g., a CD-ROM or a DVD), or a semiconductor memory, in the form of programs the computer can execute. Then, the mediums 23 can be delivered. The computer of an electronic device with a main display module 16 and an auxiliary display module 15 loads the program stored in the external storage medium 23 into a storage device 22. The computer is controlled by the read-in program, thereby realizing the function of displaying, on the auxiliary display module, a supplementary information list screen Gb corresponding to an explanatory information display screen Ga corresponding to a retrieved entry word displayed by main display module explained in the embodiment, which enables the same processes in the aforementioned methods to be performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A dictionary information display device comprising:
a dictionary data storage module which stores dictionary data that correlates a plurality of entry words with items of explanatory information about the individual entry words in a one-to-one correspondence;
an explanatory information display module which reads explanatory information corresponding to an entry word retrieved according to a user operation from the dictionary data and displays the explanatory information on a first screen;
a supplementary information list display module which reads items of supplementary information incidental to explanatory information corresponding to the retrieved entry word from the dictionary data and displays a list of the items of supplementary information on a second screen; and
a supplementary information display module which displays an item of supplementary information selected according to a user operation from the items of supplementary information displayed by the supplementary information list display module on the second screen.

2. The dictionary information display device of claim 1, wherein the supplementary information list display module reads examples and descriptions incidental to word meanings in explanatory information corresponding to the retrieved entry word from the dictionary data and displays a list of the examples and descriptions on the second screen, and
the supplementary information display module displays, on the second screen, an example or a description selected according to a user operation from the displayed examples and descriptions.

3. The dictionary information display device of claim 2, wherein the supplementary information list display module reads phrases corresponding to the retrieved entry word from the dictionary data and displays a list of the examples, descriptions, and phrases on the second screen, and
the supplementary information display module displays, on the second screen, an example, a description, or a phrase selected according to a user operation from the displayed examples, descriptions, and phrases.

4. The dictionary information display device of claim 3, wherein the supplementary information list display module displays a narrow-down key corresponding to an example, a description, and a phrase on the second screen, and
the dictionary information display device further comprises a narrow-down list display module which, when the narrow-down key displayed on the second screen is specified according to a user operation, displays a list of items corresponding to the specified narrow-down key on the second screen.

5. The dictionary information display device of claim 2, further comprising an explanatory information scroll module which scrolls, according to a user operation, explanatory information displayed on the first screen by the explanatory information display module, and
an example scroll module which scrolls a list of examples displayed on the second screen by the example list display module to a word meaning position in the explanatory information scrolled by the explanatory information scroll module and displayed on the first screen.

6. The dictionary information display device of claim 2, further comprising an explanatory information scroll module which, when an example selected according to a user operation by the supplementary information display module is displayed on the second screen, scrolls the word meaning positions in the explanatory information displayed on the first screen by the explanatory information display module to the word meaning position of the example.

7. A dictionary information display method in a dictionary information display device which includes a dictionary data storage module which stores dictionary data that correlates a plurality of entry words with items of explanatory information about the individual entry words in a one-to-one correspondence and a display module that includes a first and a second display screen, the dictionary information display method comprising:
reading explanatory information corresponding to an entry word retrieved according to a user operation from the dictionary data and displaying the explanatory information on a first screen;
reading items of supplementary information incidental to explanatory information corresponding to the retrieved entry word from the dictionary data and displaying a list of the items of supplementary information on a second screen; and
displaying, on the second screen, an item of supplementary information selected according to a user operation from the items of supplementary information displayed in list form.

8. The dictionary information display method of claim 7, further comprising:
reading examples and descriptions incidental to word meanings in explanatory information corresponding to the retrieved entry word from the dictionary data and displaying a list of the examples and descriptions on the second screen when displaying the supplementary information in list form; and
displaying an example or a description selected according to a user operation from the displayed examples and descriptions when displaying the selected supplementary information on the second screen.

9. The dictionary information display method of claim 8, further comprising:
reading phrases corresponding to the retrieved entry word from the dictionary data and displaying a list of the examples, descriptions, and phrases on the second screen when displaying the supplementary information in list form; and
displaying an example, a description, or a phrase selected according to a user operation from the displayed examples, descriptions, and phrases when displaying the selected supplementary information on the second screen.

10. The dictionary information display method of claim 9, further comprising:
displaying narrow-down keys corresponding to examples, descriptions, and phrases on the second screen when displaying the supplementary information in list form; and
displaying a list of items corresponding to a specified narrow-down key on the second screen when a narrow-down key displayed on the second screen is specified according to a user operation.

11. The dictionary information display method of claim 8, further comprising:
scrolling a list of examples displayed on the second screen to a word meaning position in the explanatory information displayed on the first screen when scrolling explanatory information displayed on the first screen according to a user operation.

12. The dictionary information display method of claim 8, further comprising:
scrolling the word meaning positions in the explanatory information displayed on the first screen to the word meaning position of an example selected according to a user operation when the example is displayed on the second screen.

13. A dictionary information display device which comprises a memory which stores dictionary data that correlates a plurality of entry words with items of explanatory information about the individual entry words in a one-to-one correspondence, a display module that includes a first and a second display screen, and a processor, the processor being caused to:
read explanatory information corresponding to an entry word retrieved according to a user operation from the dictionary data and display the explanatory information on a first screen;
read items of supplementary information incidental to explanatory information corresponding to the retrieved entry word from the dictionary data and display a list of the items of supplementary information on a second screen; and
display, on the second screen, an item of supplementary information selected according to a user operation from the items of supplementary information displayed in list form.

14. The dictionary information display device of claim 13, wherein the processor is further caused to read examples and descriptions incidental to word meanings in explanatory information corresponding to the retrieved entry word from the dictionary data and display a list of the examples and descriptions on the second screen when displaying the supplementary information in list form, and
display an example or a description selected according to a user operation from the displayed examples and descriptions when displaying the selected supplementary information on the second screen.

15. The dictionary information display device of claim 14, wherein the processor is further caused to read phrases corresponding to the retrieved entry word from the dictionary data and display a list of the examples, descriptions, and phrases on the second screen when displaying the supplementary information in list form, and
display an example, a description, or a phrase selected according to a user operation from the displayed examples, descriptions, and phrases when displaying the selected supplementary information on the second screen.

16. The dictionary information display device of claim 15, wherein the processor is further caused to display narrow-down keys corresponding to examples, descriptions, and phrases on the second screen when displaying the supplementary information in list form, and
display a list of items corresponding to a specified narrow-down key on the second screen when a narrow-down key displayed on the second screen is specified according to a user operation.

17. The dictionary information display device of claim 14, wherein the processor is further caused to scroll a list of examples displayed on the second screen to a word meaning position in the explanatory information displayed on the first screen when scrolling explanatory information displayed on the first screen according to a user operation.

18. The dictionary information display device of claim 14, wherein the processor is further caused to scroll the word meaning positions in the explanatory information displayed on the first screen to the word meaning position of an example selected according to a user operation when the example is displayed on the second screen.
